(19) United States
(12) Patent Application Publication
(10) Pub. No.: US 2019/0240882 A1
(43) Pub. Date: Aug. 8, 2019

(54) DEVICE AND METHOD FOR THE MASS PRODUCTION OF AT LEAST PARTIALLY FIBER-REINFORCED INJECTION MOLDED PARTS

(71) Applicant: Ford Global Technologies, LLC, Dearborn, MI (US)

(72) Inventors: Thomas Baranowski, Wurselen (DE); Maik Broda, Wurselen (DE); Markus Franzen, Stolberg (DE); Pascal Rebmann, Weilerswist (DE)

(73) Assignee: Ford Global Technologies, LLC, Dearborn, MI (US)

(21) Appl. No.: 16/267,593

(22) Filed: Feb. 5, 2019

(30) Foreign Application Priority Data
Feb. 7, 2018 (DE) 102018201902.9

(51) Int. Cl. B29C 45/13; B29C 45/00; B29C 31/04; B29C 35/08

(52) U.S. Cl. CPC B29C 45/13; B29C 45/0001; B29C 2035/0838; B29C 35/0805; B29C 2945/76829; B29C 31/041

(57) ABSTRACT

A device for production of at least partially fiber-reinforced injection molded parts includes at least one injection molding tool, with at least one first tool part and at least two second tool parts that can be selectively connected to the first tool part in order to form an injection molding cavity. The device also includes at least one placement unit, at least one injection unit and at least one electronic control. The at least one placement unit automatically places at least one tape section of a fiber-reinforced plastic tape on a cavity section of one of the second tool parts or on an injection molded workpiece disposed on said cavity section. The at least one injection unit injects a molding compound into the respective injection molding cavity and the at least one electronic control controls the placement unit and the injection unit.

### CROSS-REFERENCE TO RELATED APPLICATIONS

This application is a continuation of German Application No. DE 102018201902.9, filed on Feb. 7, 2018. The disclosure of the above application is incorporated herein by reference.

### FIELD

The present disclosure relates to a device for producing fiber-reinforced injection molded parts.

### BACKGROUND

The statements in this section merely provide background information related to the present disclosure and may not constitute prior art.

Stringent ecological, economic and political requirements, in particular in vehicle construction, lead to an increasing use of lightweight solutions in the form of fiber-reinforced injection molded parts. It may be necessary to reinforce an injection molded part so that the injection molded part can withstand the mechanical loads when used for its intended purpose. In this regard, injection molded parts which are only locally fiber-reinforced are significantly less expensive to produce than parts that are produced entirely from a fiber composite material. For local reinforcement, a reinforcing element may be disposed on an injection molded part which could itself, for example, be produced from a fiber composite material. The reinforcing element may, for example, be produced as a fiber-reinforced plastic tape which comprises continuous reinforcing fibers embedded in a matrix material made from plastic. Applications are known in which a reinforcing element of this type is overmolded or at least partially extrusion coated with a particular injection molding material used during the production of an injection molded part.

The greatest challenge when using a reinforcing element in the form of a fiber-reinforced plastic tape, also known as tape, in mass production applications arises in the process for manufacturing injection molded parts. Manual or automatic placement of a tape in an injection molding tool can be extremely time-consuming in this instance. In this case a robot or an operative has to place the thin tape in the injection molding tool before the injection molding process can be started. This results in an ineffective production process, in particular because of the manual procedural steps and the risk that the positioning tolerances that are required will not be met. Using a robot instead of an operative is more effective as regards timing and precision but is more expensive and requires more space.

In addition, a tape which is disposed in the injection molding tool usually has to be fixed to the injection molding tool using additional means such as, for example, by means of clamping equipment, by producing a vacuum, by using an adhesive or the like, in order to prevent the position of the tape from changing during the production of the injection molded part. Using such fixing means results in an inefficient production process because of the additional time required in this instance and the risk associated with the manual placement of the tape that the required positioning tolerances will not be met.

Furthermore, in a conventional injection molding process, in order to place a tape in a conventional injection molding tool, the injection molding tool has to be opened so that the injection molding cavity inside it is accessible. This means that the process steps of the placement of the tape and of the injection molding have to be carried out one after the other, which leads to a correspondingly long production time.

U.S. Pat. No. 6,495,091B1 discloses a method for the production of polymer and/or composite products, comprising the integration of processing operations to carry out a plurality of material conversion steps, such as, for example, impregnation and consolidation, within a single controlled manufacturing cycle, including a final in-situ preparation of at least one composite preform at the location of the molding operation. The method includes an integrated molding operation comprising a step of providing an additional material functioning as a matrix into the mold to at least partially enclose the composite preform, wherein the operation of providing the additional material functioning as a matrix provides the pressure for an in-situ final consolidation of the composite product.

Korean patent No. KR 101026017B1 discloses an automatic tape layup system using a multi layup arrangement in order to improve productivity by continuously operating the automatic tape layup system, and in order to select the sequence for laying up. The automatic tape layer system that uses a multi layup comprises multiple molds, a layup device and a control unit. The layup device lays up and presses a material onto the molds. The control unit successively controls the operation of the layup device by means of a program. The control unit operates the layup device continuously. The program is operated by selecting the work order of the molds.

United States Patent Publication No. US 2012/0125517A1 discloses a prepreg peel ply material for use in improving the surface roughness of a composite laminate, comprising a backing paper and a base fabric impregnated with a thermosetting resin, wherein the adhesion between the backing paper and the base fabric, measured using a peel-off parameter P, is between 2.9-3.5 min/N/cm², and the adhesion between the base fabric and the composite material, measured by the parameter P, is between 130-160 min/N/cm².

United States Patent Publication No. US 2013/0319607A1 discloses a system for flash-free overmolding of LED array substrates. A method for molding encapsulations onto the LED array substrate comprises placing a protective tape onto a substrate surface of the substrate so that openings in the protective tape align with LED devices of the substrate and applying molding material onto a mold surface of a molding tool and onto portions of the substrate exposed through the openings in the protective tape. The method also includes pressing the mold surface and the substrate surface together at a selected pressure and a selected temperature, so that encapsulations are formed on the portions of the substrate exposed through the openings in the protective tape, whereupon the mold surface is separated from the substrate surface. The method also comprises removing the protective tape so that a molding material flash is removed from the substrate, leaving a clean molded substrate.

United States Patent Publication No. US 2009/0152746A1 discloses an overmolding tool for the process of overmolding onto a fiber optic cable assembly. The overmolding tool includes first and second molding tool sets. The first molding tool set applies a first portion of the overmold onto the fiber optic cable assembly. The second molding tool set then applies a second portion of the overmold onto the fiber optic cable assembly. In preferred embodiments, the first and the second portions of the overmold fuse to each other. By employing the first and the second molding tool sets, the fiber optic cable assembly can be held at closer intervals along its length when being overmolded compared with a single, longer molding tool set. In addition, a lower capacity injection pump can be used when applying the overmold in two portions. In other embodiments, additional molding tool sets can be added that sequentially apply additional portions of the overmold.

U.S. Pat. No. 6,210,619 B1 discloses a method for manufacturing a two-piece plastic assembly from a single mold set with the following steps: providing a molding device with a first mold that can be moved between first and second positions and a second mold, wherein the first mold has a first surface and a second surface and the second mold has a third surface and a fourth surface; moving the first mold into the first position and closing the device, whereupon the first and third surfaces delimit a first article cavity and the second and fourth surfaces delimit a second article cavity; injecting a first plastic material into the first article cavity; injecting a second plastic material into the second article cavity; cooling the first material to form a first article and cooling the second material to form a second article; opening the mold; moving the first mold into the second position; closing the mold and positioning the first article opposite the second article to enclose a joining cavity therebetween; injecting a third plastic material into the joining cavity and joining the first article to the second article to form the plastic assembly.

Coriolis in Quéven, France discloses an automated placement of reinforcing fibers on an injection molding tool (see http://www.coriolis-software.com/contacts-software/contact-us.html)

Brecher et al. discloses cost-effective high-speed manufacture of composite parts by selective and multi-layered layup of a tape on a tool part. (Cost-Effective High Speed Production of Multi-Material Components By Selective Tape Placement, Brecher et al., 10^{th} international Conference on Composite Science and Technology, ICCST/10, 2015).

Stokes-Griffing et al. discloses a combined optical-thermal model for laser heating thermoplastic composite parts during the automated layup of a tape on a tool part. (A combined optical-thermal model for near-infrared laser heating of thermoplastic composites in an automated tape placement process, Stokes-Griffing et al., Composites Part A: Applied Science and Manufacturing, 2014).

U.S. Pat. No. 8,574,388 B2 discloses a method and device for the automated production of an elongated composite material part having at least one layer. The method comprises the layup, by unrolling onto a tool part in a first direction along the tool part, of an assembly having a composite material layer that is separably attached to a substrate tape and forming and compacting a part of the assembly on the tool part. The assembly is partially shaped into the shape of the tool part. Next, a remaining portion of the assembly is formed and compacted in a second direction, opposite the first direction, in order to shape the assembly completely into the shape of the tool part. Next, the assembly is separated by peeling the substrate tape from the composite material layer that is secured to the tool part, by unrolling the substrate tape in the second direction.

United States Patent Publication No. US 2016/0332392A1 discloses a method for forming composite components in which a composite layup is produced using various fiber types across the layup. This can adapt the layup to molding processes in regions of the layup to be molded and uses fiber types which give the greatest strength benefits in regions that do not need to be molded. Regions not requiring molding may contain binders that are activated prior to a molding step or steps, after which the molded regions can be impregnated with a matrix and the components can be cured.

United States Patent Publication No. US 2016/0221223A1 discloses a pre-prepared molding tool having a thermoplastic surface layer polymer coating on the mold surface of the molding tool or a prepared prepreg having a thermoplastic surface layer polymer coating on the surface of the thermoplastic fiber-reinforced prepreg that enhance layup of the first ply of thermoplastic fiber-reinforced composite prepreg onto molding tools for prepreg molding or in-situ tape layup. The thermoplastic fiber-reinforced composite parts produced from a thermoplastic fiber-reinforced thermoplastic composite material comprise structural reinforcing fibers with one or more high performance polymers and a thermoplastic surface layer polymer coating that forms a polymer blend with the high-performance polymers of the thermoplastic fiber-reinforced composite material, thereby providing improved properties and a method for the production and use thereof is also provided.

U.S. Pat. No. 9,259,859 B2 discloses a method for shaping dry preform material prior to resin infusion. The starting material to be shaped is a preform blank (e.g. flat sheet) of dry, fibrous material. The shaping process is a vacuum forming process that relies on controlling the vacuum pressure and rate of deformation in order to produce a shaped preform with a three-dimensional configuration. The purpose of the shaping process is to enable the conventional hand layup operation to be replaced by an automated process.

U.S. Pat. No. 8,153,258 B2 discloses a molded part with reduced squeaking and rattling. The molded part comprises a first component of a vehicle that has a first surface. The molded part also includes a second component of a vehicle having a second surface. The second component is mounted on the first component. An isolator is disposed between the first and second components and is secured to the first surface. The isolator comprises an injection moldable self-lubricating elastomer impregnated with a fatty amide. An interface between the isolator and the second surface has a ratio of a coefficient of static friction to a coefficient of dynamic friction of less than 1.4.

The present disclosure addresses the issues of mass production of at least partially fiber-reinforced injection molded parts among other issues related to reducing the production costs.

### SUMMARY

This section provides a general summary of the disclosure and is not a comprehensive disclosure of its full scope or all of its features.

The present disclosure relates to a device for the mass production of at least partially fiber-reinforced injection molded parts, in particular vehicle parts, comprising: at least one injection molding tool, which comprises at least one first tool part and at least two second tool parts that can be selectively connected to the first tool part in order to form an injection molding cavity; at least one placement unit for automatically placing at least one tape section of a fiber-reinforced plastic tape on a cavity section of one of the second tool parts or on an injection molded workpiece disposed on said cavity section; at least one injection unit for injecting a molding compound into the respective injection molding cavity; and at least one electronic control to control the placement unit and the injection unit.

Furthermore, the present disclosure relates to a method for the mass production of at least partially fiber-reinforced injection molded parts, in particular vehicle parts, using an injection molding tool with at least one first tool part and at least two second tool parts that can be selectively connected to the first tool part in order to form an injection molding cavity.

The present disclosure is achievable by a device, in which the electronic control is configured in a manner such as to activate the placement unit during injection of the molding compound into the respective injection molding cavity and/or during cooling of the molding com-pound that has been injected into said injection molding cavity.

In accordance with the present disclosure, the step of the method for placing the tape section of the fiber-reinforced plastic tape on the cavity section of the respective second tool part, and optionally also additionally removing a previously produced injection molded part from that second tool part, is carried out at the same time as the step of the method for injecting the molding compound into the respective injection molding cavity that is formed by using a further, second tool part together with the first tool part, and/or at the same time as the step of the method for cooling the molding compound that has been injected into said injection molding cavity. These steps of the method are chronologically parallel, whereupon the productivity can be raised, and because placement of the tape section on the respective cavity section is automated, process robustness and process precision can simultaneously be improved. In contrast to a conventional method, in the device in accordance with the present disclosure, at least one (second) tool part is always available for placement of a tape section of the fiber-reinforced plastic tape, even when an injection procedure is currently being carried out using the device. The increased productivity is coupled with economic advantages, in particular because personnel costs can be reduced.

Because the placement unit is electrically controlled by the electronic control, the placement unit is activated so that the placement unit carries out its intended function, namely the placement of at least one tape section of the fiber-reinforced plastic tape on at least one cavity section of at least one second tool part. The placement unit may in particular be configured as a placement robot. The electronic control is also configured to activate the injection unit to inject the molding compound or injection molding compound into the respective injection molding cavity. Furthermore, the electronic control may be configured to electrically control at least one actuator in a manner such that the second tool parts can be selectively connected to the first tool part in order to form the respective injection molding cavity and be detached therefrom again.

The first tool part and/or the second tool parts may be in a movable manner disposed, so that the first tool part can be selectively connected to one of the second tool parts. Each tool part may be partially or completely produced from a steel, aluminum, thermoset or the like, for example. Similarly, a cavity section is disposed on each second tool part which forms the respective injection molding cavity with the cavity section on the first tool part.

The placement unit enables at least one tape section of the fiber-reinforced plastic tape, in particular two or more tape sections, to be placed automatically on the cavity section of one of the second tool parts or on one of the injection molded workpieces disposed on said cavity section. This allows for subsequent overmolding or extrusion coating of the tape section or tape sections so that overall, an injection molded part can be produced into which the tape section or the tape sections are embedded.

The injection unit for injecting a molding compound into the respective injection molding cavity may be configured in a conventional manner. The molding compound may, for example, have a thermoplastic or thermoset plastic component, or be formed completely from a thermoplastic or thermoset material. The molding compound may or may not contain reinforcing fibers or another filler such as talc, for example. Apart from any filler which may optionally be contained therein, the molding compound may, for example, be produced from polypropylene, a polyamide, polyoxymethylene, a polycarbonate or an acrylonitrile-butadiene-styrene copolymer. In order to reinforce the fibers of the molding compound, it may contain short or long reinforcing fibers. As an example, glass fibers, carbon fibers, aramid fibers or other artificial or natural fibers may be used for fiber reinforcement. The molding compound may also be foamed using a physical or chemical foaming process in order to reduce the weight of the injection molded part.

The fiber-reinforced plastic tape may be formed as a flat tape with unidirectionally, bidirectionally or multidirectionally oriented reinforcing fibers in the longitudinal direction of the tape. The plastic tape may be constructed from two or more layers with differing fiber orientations. The plastic tape may comprise a polymer material into which the reinforcing fibers are at least partially embedded. The polymer material may be similar to or identical to the plastic component of the molding compound, particularly as regards its melting temperature, so that the polymer material can bond in a material bonding manner with the plastic component of the molding compound during injection molding. In this manner, detachment of the tape section or tape sections from the remaining injection molded part is reliably inhibited. The reinforcing fibers of the plastic tape may, for example, be glass fibers, carbon fibers, aramid fibers or other artificial or natural fibers.

The placement unit may comprise at least one replenishable supply unit in order to supply the fiber-reinforced plastic tape. Furthermore, the feeding device is provided with at least one electrically controllable drive device with which the fiber-reinforced plastic tape can be moved in sections from the supply unit to the placement unit. The supply unit or the placement unit may be configured so as to emit a signal when the quantity of plastic tape still available in the supply unit falls below a predetermined threshold value.

The supply unit may comprise at least one holding unit and at least one replaceable plastic tape reel disposed on the holding unit and which can be unwound. The plastic tape reel acts as the supply unit for the fiber-reinforced plastic tape. The plastic tape reel may be disposed on the holding unit, wherein a section of the holding unit is fed through a central axial opening of the plastic tape reel. If a new plastic tape reel is disposed on the holding unit, the free tape section of the plastic tape can firstly be manually or automatically connected to the placement unit. The placement unit may also comprise at least one electrically controllable drive for unwinding the plastic tape reel. The electronic control may also be used to control the drive. In one form of the present disclosure, the drive is an electric motor by which the plastic tape reel can be rotated about its longitudinal central axis.

The device in accordance with the present disclosure may in particular be used for the mass production of at least partially fiber-reinforced injection molded parts in the form of vehicle parts. In addition, the present disclosure enables multi-material technology to be employed in which, for example, rigid or elastic plastics can be used and combined with each other, during which additional functional elements can be added, and the like.

In accordance with an advantageous form, the two second tool parts are disposed on mutually opposing sides of a holding unit holding or forming the two second tool parts, wherein a distance between the first tool part and the holding unit can be varied along a linear path of movement and the holding unit is rotatably disposed about a rotary axis oriented transversely to the linear path of movement. In this manner, the holding unit can take up two functional positions, namely one in which one of the two second tool parts is connected to the first tool part in order to form an injection molding cavity, while the other of the two second tool parts is accessible to the placement unit, and one in which the other of the two second tool parts is connected to the first tool part in order to form an injection molding cavity, while the one of the two second tool parts is accessible to the placement unit. The holding unit may be manually or automatically rotated about the rotary axis by an actuator which may, for example, be controllable by the electronic control.

In a further advantageous form, the injection molding tool comprises at least one third tool part disposed on a side of the holding unit lying opposite to the first tool part, which can be selectively connected to one of the second tool parts in order to form an injection molding cavity, wherein a distance between the third tool part and the holding unit can be varied along a linear path of movement, and four second tool parts that are uniformly circumferentially spaced with respect to each other on the holding unit about the rotary axis, wherein the placement unit is configured in a manner such that, during injection of the molding compound into the two injection molding cavities between the respective second tool parts on the one hand and the first tool part or the third tool part on the other hand and/or during cooling of the molding compounds injected into the two injection molding cavities, at least one tape section of the fiber-reinforced plastic tape is placed on the respective two second tool parts that are not connected to the first tool part or to the third tool part. In this manner, the time taken to produce identical injection molded parts using the device can be further reduced, because at least one tape section of the fiber-reinforced plastic tape can be disposed respectively on two second tool parts or their cavity sections disposed on mutually opposing sides of the injection molding mold halves, while the other two second tool parts or their cavity sections cooperate with the first tool part or the third tool part in a manner such that in each case, a closed injection molding cavity is formed and injection molding can be carried out. After injection molding has been completed successfully, the injection molding cavities can be opened by a linear movement of the first tool part, the holding unit and/or the third tool part, so that the holding unit can be rotated through 90°. In this position, then, the injection molded parts can be removed from the cavity sections of the second tool parts, so that their cavity sections are once again freed in order that at least one tape section of the fiber-reinforced plastic tape can be once more disposed in the respective cavity section. Simultaneously, after a linear movement of the first tool part, the holding unit and/or the third tool part, the two further second tool parts can cooperate with the first tool part or the third tool part in a manner such that a respective closed injection molding cavity is formed, and injection molding can be carried out. Laying-up of tape sections of the fiber-reinforced plastic tape at mutually opposing second tool parts can thus be carried out at the same time as the production of injection molded parts by the two further second tool parts, whereupon the time for producing identical injection molded parts is reduced. In addition, with the device, two injection molded parts are always produced simultaneously, which also reduces the time for producing identical injection molded parts.

In accordance with another advantageous form, the cavity section of at least one of the second tool parts is provided, at least in regions, with a chemically and/or physically treated surface in order to improve its adhesive properties. In this manner, adhesion between the cavity section and the tape section disposed directly thereon can be maintained, such that the tape section can be securely retained on the cavity section even during injection of the molding compound into the relevant injection molding cavity, but which, however, following cooling of the molding compound injected into the injection molding cavity and subsequent opening of the injection molding tool, such that the finished injection molded part can easily be released from the cavity section. Because of the enhanced adhesion of the tape section to the cavity section, further fixing of the tape section are rendered superfluous. Instead, the placement unit can place the tape section directly and swiftly on the cavity section, with the result that, compared with the conventional use of fixing such as grips, clamps, vacuum producers, an adhesive and the like, for example, time is saved and thus productivity is higher. The chemical and/or physical treatment of the surface of the cavity section may, for example, be carried out by a heat treatment of the surface and/or texturing of the surface, the latter producing a larger surface area for adhesion.

In a further advantageous form, the placement unit comprises at least one supply unit to supply the plastic tape, at least one compaction roller for progressive compaction of a tape section of the plastic tape that is progressively removed from the supply unit, and at least one laser source for irradiation of an advancing connecting region between the tape section and the cavity section of the respective second tool part or the injection molded workpiece disposed on the cavity section. The laser source enables heating of the advancing connecting region between the tape section and a tape section which could already be disposed on the cavity section, the cavity section of the respective second tool part or the injection molded workpiece disposed on the cavity section, whereupon in particular, the plastic component of the fiber-reinforced tape section can be partially fused so that it binds as intimately as possible, for example also in a material-bonding manner, with the respective underlying material.

The above desires are also achieved by a method in which, during injection of the molding compound into the respective injection molding cavity formed with one of the second tool parts and/or during cooling of the molding compound injected into said injection molding cavity, at least one tape section of a fiber-reinforced plastic tape is automatically placed on a cavity section of the other of the second tool parts or on an injection molded workpiece disposed on this cavity section.

The aforementioned advantages of the device correspondingly pertain to the method. In particular, the method can be carried out with the device in accordance with one of the aforementioned forms or a combination of at least two of these forms.

In accordance with an advantageous form, the tape section is progressively placed with the cavity section of the respective second tool part or the injection molded workpiece disposed on the cavity section, wherein a section in front of the thus-advancing connecting region of the tape section on the one hand and of the cavity section or the injection molded workpiece on the other hand is heated. The aforementioned advantages of the corresponding form of the device also pertain to this form. Heating of the advancing connecting region may therefore be carried out by a laser source.

In a further advantageous form, a surface of the cavity section of at least one of the second tool parts is treated chemically and/or physically at least in areas prior to placement of the tape section of the plastic tape, in order to improve its adhesive properties. The aforementioned advantages of the corresponding form of the device also pertain to this form.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a schematic representation of an exemplary form of a device, according to the teachings of the present disclosure;

FIG. 2 shows a schematic representation of a second tool part of a further exemplary form of a device, according to the teachings of the present disclosure;

FIG. 3 shows a schematic representation of a placement unit of a further exemplary form of a device, according to the teachings of the present disclosure; and

FIG. 4 shows a flow diagram of an exemplary form of a method, according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features. Examples are provided to fully convey the scope of the disclosure to those who are skilled in the art. Numerous specific details are set forth such as types of specific components, devices, and methods, to provide a thorough understanding of variations of the present disclosure. It will be apparent to those skilled in the art that specific details need not be employed and that the examples provided herein, may include alternative forms and are not intended to limit the scope of the disclosure. In some examples, well-known processes, well-known device structures, and well-known technologies are not described in detail.

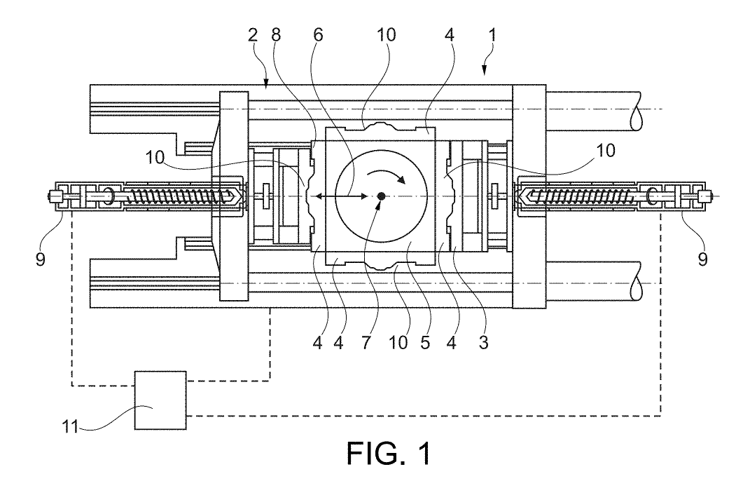

Referring to FIG. 1, a form of the present disclosure is shown, a schematic representation of an exemplary form of a device 1 in accordance with the present disclosure for the mass production of at least partially fiber-reinforced injection molded parts (not shown).

The device 1 comprises an injection molding tool 2 which comprises a first tool part 3 and four second tool parts 4 which can be selectively connected with the first tool part 3 in order to form an injection molding cavity (not shown). In each case, two of the second tool parts 4 are disposed on mutually opposing sides of a holding unit 5 which holds or forms the four second tool parts 4. A distance between the first tool part 3 and the holding unit 5 can be varied along a linear path of movement which is indicated by the double-headed arrow 6. The holding unit 5 is rotatably disposed about a rotary axis 7 oriented transversely to the linear path of movement.

In addition, the injection molding tool 2 comprises a third tool part 8 disposed on a side of the holding unit 5 lying opposite to the first tool part 3, which can be selectively connected to one of the second tool parts 4 in order to form an injection molding cavity (not shown). A distance between the third tool part 8 and the holding unit 5 can be varied along the linear path of movement. The second tool parts 4 are uniformly circumferentially spaced with respect to each other on the holding unit 5 about the rotary axis 7.

Furthermore, the device 1 comprises at least one injection unit 9 for injecting a molding compound into the respective injection molding cavity. Two mutually opposing injection units 9 can be seen, by way of example.

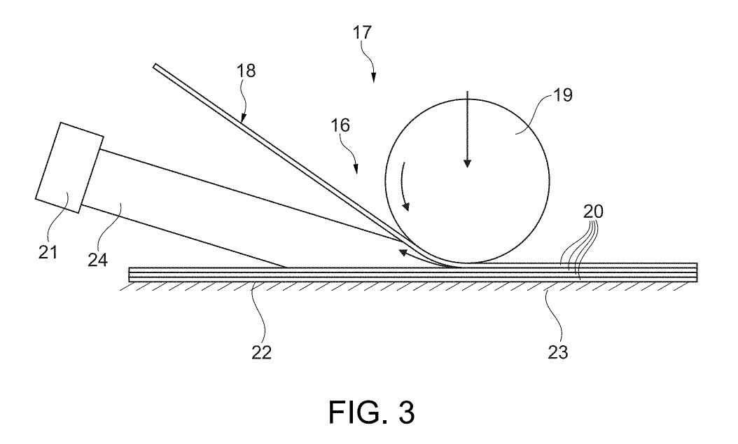

In addition, the device 1 comprises at least one placement unit (not shown) for automated placement of at least one tape section (not shown) of a fiber-reinforced plastic tape (not shown) on a cavity section 10 of one of the second tool parts 4 or on an injection molded workpiece (not shown) disposed on said cavity section 10. The placement unit may, for example, be configured in accordance with FIG. 3. The cavity section 10 of at least one of the second tool parts 4 may be provided with a chemically and/or physically treated surface (not shown) in order to improve its adhesive properties.

Furthermore, the device 1 comprises an electronic control 11 to control the placement unit and the injection unit 9. The electronic control 11 is configured in a manner such that the placement unit is activated during injection of the molding compound into the respective injection molding cavities and/or during cooling of the molding compound injected into these injection molding cavities. During injection of the molding compound into the two injection molding cavities between the respective second tool parts 4 on the one hand and the first tool part 3 or the third tool part 8 on the other hand and/or during cooling of the molding compounds injected into the two injection molding cavities, the placement unit is configured to respectively place at least one tape section of the fiber-reinforced plastic tape onto the respective two second tool parts 4 that are not connected to the first tool part 3 or to the third tool part 8.

The placement unit may comprise at least one supply unit (not shown) to supply the fiber-reinforced plastic tape, at least one compaction roller (not shown) for progressive compaction of a tape section of the fiber-reinforced plastic tape that is progressively removed from the supply unit, and at least one laser source (not shown) for irradiation of an advancing connecting region between the tape section and the cavity section 10 of the respective second tool part 4 or the injection molded workpiece disposed on the cavity section 10.

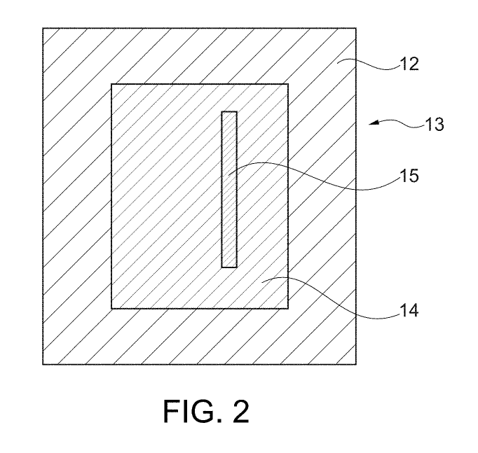

Now referring to FIG. 2, another form of the present disclosure is shown, a schematic representation of a second tool part 12 of a further exemplary form of a device 13 in accordance with the present disclosure for the mass production of at least partially fiber-reinforced injection molded parts (not shown). The device 13 may otherwise be configured in accordance with the exemplary form shown in FIG. 1.

The cavity section 14 of the second tool part 12 is shown, on which a tape section 15 of a fiber-reinforced plastic tape (not shown) is disposed. The cavity section 14 is connected to the tape section by the placement unit (not shown) of the device 13 in a manner such that no additional fixing is desired to fix the tape section to the cavity section 14. In this regard, the cavity section 14 is provided, at least in regions, with a chemically and/or physically treated surface in order to improve its adhesive properties.

Referring now to FIG. 3, yet another form of the present disclosure is shown, a schematic representation of a placement unit 16 of a further exemplary form of a device 17 in accordance with the present disclosure for the mass production of at least partially fiber-reinforced injection molded parts (not shown). The device 17 may otherwise be configured in accordance with the exemplary form shown in FIG. 1.

The placement unit 16 comprises at least one supply unit (not shown) to supply the fiber-reinforced plastic tape 18, at least one compaction roller 19 for progressive compaction of a tape section 20 of the plastic tape 18 that is progressively removed from the supply unit, and at least one laser source 21 for irradiation of an advancing connecting region between the tape section 20 and the cavity section 22 of the respective second tool part 23 or the tape section 20 that is already disposed on the cavity section 22, using a laser beam 24. Further, FIG. 3 shows that a fourth tape section 20 has already been placed in this manner using the placement unit 16.

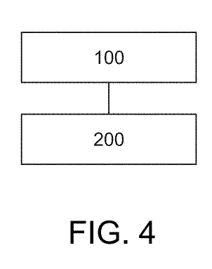

Referring to FIG. 4, one form of the present disclosure is shown, a flow diagram of an exemplary form of a method in accordance with the present disclosure for the mass production of at least partially fiber-reinforced injection molded parts using an injection molding tool with at least one first tool part and at least two second tool parts that can be selectively connected to the first tool part in order to form an injection molding cavity.

In step 100 of the method, a surface of the cavity section of at least one of the second tool parts is treated chemically and/or physically at least in regions prior to the placement of the tape section of the plastic tape in order to improve its adhesive properties. The step 100 of the method is stored for efficient production and for one run, it is expediently only carried out once.

In step 200 of the method, during injection of the molding compound into the injection molding cavity respectively formed with one of the second tool parts and/or during cooling of the molding compound injected into said injection molding cavity, at least one tape section of a fiber-reinforced plastic tape is automatically placed on a cavity section of the other of the second tool parts or on an injection molded workpiece disposed on said cavity section. In this regard, the tape section is progressively placed on the cavity section of the respective second tool part or the injection molded workpiece disposed on the cavity section, wherein a section in front of the thus-advancing connecting region of the tape section on the one hand and of the cavity section or the injection molded workpiece on the other hand is heated.

### REFERENCE LIST

1 device;
2 injection molding tool;
3 first tool part;
4 second tool part;
5 holding unit;
6 double-headed arrow (linear path of movement);
7 rotary axis of 5;
8 third tool part;
9 injection unit;
10 cavity section of 4;
11 electronic control;
12 second tool part;
13 device;
14 cavity section of 12;
15 tape section;
16 placement unit;
17 device;
18 plastic tape;
19 compaction roller;
20 tape section;
21 laser source;
22 cavity section of 23;
23 second tool part;
24 laser beam;
100 step of method (surface treatment); and
200 step of method (injection molding and placement).

When an element or layer is referred to as being “on” or “thereon” another element or layer, it may be directly on the other element or layer, or intervening elements or layers may be present. In contrast, when an element is referred to as being “directly on” or “directly thereon” another element or layer, there may be no intervening elements or layers present. Other words used to describe the relationship between elements should be interpreted in like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used to describe various elements, components, regions, layers and/or sections, these elements, components, regions, layers and/or sections, should not be limited by these terms. These terms may be only used to distinguish one element, component, region, layer and/or section, from another element, component, region, layer and/or section. Terms such as “first,” “second,” and other numerical terms when used herein do not imply a sequence or order unless clearly indicated by the context. Thus, a first element, component, region, layer or section, could be termed a second element, component, region, layer or section without departing from the teachings of the example forms. Furthermore, an element, component, region, layer or section may be termed a “second” element, component, region, layer or section, without the need for an element, component, region, layer or section termed a “first” element, component, region, layer or section.

Spacially relative terms, such as “below,” “lower,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above or below. The device may be otherwise oriented (rotated 90 degrees or at other orientations) and the spatially relative descriptors used herein interpreted accordingly.

As used herein, the phrase at least one of A, B, and C should be construed to mean a logical (A OR B OR C), using a non-exclusive logical OR, and should not be construed to mean “at least one of A, at least one of B, and at least one of C.

Unless otherwise expressly indicated, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, manufacturing technology, and testing capability.

The terminology used herein is for the purpose of describing particular example forms only and is not intended to be limiting. The singular forms “a,” “an,” and “the” may be intended to include the plural forms as well, unless the context clearly indicates otherwise. The terms “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The description of the disclosure is merely exemplary in nature and, thus, examples that do not depart from the substance of the disclosure are intended to be within the scope of the disclosure. Such examples are not to be regarded as a departure from the spirit and scope of the disclosure. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A device for production of at least partially fiber-reinforced injection molded parts comprising:
at least one injection molding tool, which comprises at least one first tool part and at least two second tool parts that are selectively connected to the first tool part in order to form an injection molding cavity;
at least one placement unit for automatically placing at least one tape section of a fiber-reinforced plastic tape on a cavity section of one of the second tool parts or on an injection molded workpiece disposed on said cavity section;
at least one injection unit for injecting a molding compound into the injection molding cavity; and
at least one electronic control to control the placement unit and the injection unit,
wherein the electronic control is configured to activate the placement unit during at least one of injection of the molding compound into the respective injection molding cavity and cooling of the molding compound injected into said injection molding cavity.

2. The device according to claim 1, wherein the two second tool parts are disposed on mutually opposing sides of a holding unit holding the two second tool parts, wherein a distance between the first tool part and the holding unit can be varied along a linear path of movement and the holding unit is rotatably disposed about a rotary axis oriented transversely to the linear path of movement.

3. The device according to claim 2, wherein the injection molding tool comprises at least one third tool part disposed on a side of the holding unit lying opposite to the first tool part, which can be selectively connected to one of the second tool parts in order to form an injection molding cavity, wherein a distance between the third tool part and the holding unit can be varied along a linear path of movement, and four second tool parts that are uniformly circumferentially spaced with respect to each other on the holding unit about the rotary axis, wherein the placement unit is configured in a manner such that, during injection of the molding compound into the two injection molding cavities between the respective second tool parts on the one hand and the first tool part or the third tool part on the other hand and/or during cooling of the molding compounds injected into the two injection molding cavities, at least one tape section of the fiber-reinforced plastic tape is placed on the respective two second tool parts that are not connected to the first tool part or to the third tool part.

4. The device according to claim 1, wherein the cavity section of at least one of the second tool parts is provided, at least in regions, with a chemically and/or physically treated surface in order to improve its adhesive properties.

5. The device according to claim 1, wherein the placement unit comprises at least one supply unit to supply the fiber-reinforced plastic tape, at least one compaction roller for progressive compaction of a tape section of the fiber-reinforced plastic tape that is progressively removed from the supply unit, and at least one laser source for irradiation of an advancing connecting region between the tape section and the cavity section of the respective second tool part or the injection molded workpiece disposed on the cavity section.

6. A method for production of at least partially fiber-reinforced injection molded parts comprising:
injection molding a plurality of an at least partially fiber-reinforced injection molded parts using an injection molding tool with at least one first tool part and at least two second tool parts selectively connected to the first tool part in order to form an injection molding cavity, wherein at least one tape section of a fiber-reinforced plastic tape is automatically placed on a cavity section of the other of the second tool parts or on an injection molded workpiece disposed on the cavity section during at least one of injection of a molding compound into the injection molding cavity formed with one of the second tool parts and cooling of the molding compound injected into the injection molding cavity.

7. The method according to claim 6, wherein the at least one tape section is progressively placed on the cavity section of the respective second tool part or the injection molded workpiece disposed on the cavity section, wherein at least one of a section in front of an advancing connecting region of the at least one tape section, the cavity section and the injection molded workpiece is heated.

8. The method according to claim 7, wherein a surface of the cavity section of at least one of the second tool parts is treated chemically and/or physically prior to the placement of the tape section of the fiber-reinforced plastic tape in order to improve the adhesive properties of the surface.
